(19) United States
(12) Patent Application Publication
(10) Pub. No.: US 2016/0208903 A1
(43) Pub. Date: Jul. 21, 2016

(54) Chainrings with Alternating Tooth Thickness Offset

(71) Applicant: Wick Werks, LLC, Ogden, UT (US)

(72) Inventor: Eldon L. GOATES, Colorado Springs, CO (US)

(21) Appl. No.: 15/080,378

(22) Filed: Mar. 24, 2016

Related U.S. Application Data
(60) Provisional application No. 62/138,028, filed on Mar. 25, 2015.

(51) Int. Cl. F16H 55/30; B62M 9/00; F16G 13/06

(52) U.S. Cl. CPC F16H 55/303; F16G 13/06; B62M 9/00

(57) ABSTRACT

A bicycle chainring for engaging a bicycle drive chain has a plurality of teeth formed around its periphery. The plurality of teeth includes a first group of teeth, and a second group of teeth. The teeth of the second group are arranged alternatingly between the teeth of the first group. A portion of each tooth of the first group extends outwardly on a first lateral side of the chainring, and a portion of each tooth of the second group extends outwardly on the second lateral side of the chainring. Thus, each tooth is arranged in a laterally staggered position relative to its neighboring teeth. A bicycle chain drive employs the chainring. This construction of the chain drive and chainring offer the retention advantages of Narrow-Wide chainrings, but also allow the chain to engage with the chainring at multiple orientations.

### CROSS-REFERENCE TO RELATED APPLICATIONS

Priority is claimed to U.S. Provisional Patent Application No. 62/138,028, filed on Mar. 25, 2015, the contents of which are incorporated by reference herein in their entirety.

### BACKGROUND OF THE INVENTION

This invention relates to bicycle components, and in particular to chainrings used in bicycles. Bicycles commonly use a roller chain to transfer force from a pedal through a crank to a sprocket (a chainring) or set of sprockets (chainrings) in a crankset, and then via the chain to another sprocket or set of sprockets connected to the axle of the wheel to be turned by the force. Sprockets at either the front or rear transfer torque from the cyclist by engaging sprocket teeth between the rollers of the bicycle drive chain—a chain made up of segments or links—with the links typically made with plates that are joined via pins passing through the link plates and rollers. The links are assembled with one set of joining plates inside (nearer the rollers) and one of joining plates set outside, thus creating the inner and outer chain links. Thus there is a side-to-side spacing difference for the inner and outer links.

The teeth of the sprocket extend into the spaces or gaps bounded between rollers longitudinally, and between the side plates axially. To match as exactly as practical these spaces, one prior solution is to make every other tooth of the sprocket wider, so as to fit closely between the outer links of the chain. Then, each narrow tooth (every other tooth in the arrangement) is made to fit closely between the inner links of the chain. This configuration is frequently called “Narrow-Wide” in the bicycling industry, and will be referred to as “Narrow-Wide” hereinafter. This Narrow-Wide configuration offers some advantages in 1) chain retention (when the bicycle is ridden on very rough terrain, as in mountain biking, the chain can be violently jostled but stay in place); and 2) keeping the chain tracking onto the chainring even when front and rear sprockets are not co-planar.

Disadvantages of the Narrow-Wide technology include constraining chain position such that only the outer chain links fit over the wide teeth—complicating assembly of the bicycle drivetrain in some instances. Only even numbers of teeth may be used, and Narrow-Wide chainrings cannot be used practically in a shifting sprocket system.

Traditional chainrings with teeth of all the same width in a straight alignment, with no tooth that is “wide” or “narrow” compared to the other teeth, are also used for bicycle applications. These chainrings have been the most common, but have been known to “throw” the chain in really rough terrain—especially when the chain alignment is such that the front sprocket on the crankset and the rear sprocket on the wheel axle are not aligned upon the same plane.

### SUMMARY OF THE INVENTION

The invention provides a bicycle chainring for engaging a bicycle drive chain having a plurality of teeth formed about the periphery of the chainring. The plurality of teeth includes a first group of teeth, and a second group of teeth. The teeth of the second group are arranged alternatingly between the teeth of the first group. Every tooth, whether in the first group or in the second group, has the same width or thickness, but a portion of each tooth of the first group extends outwardly on a first lateral side of the chainring, and a portion of each tooth of the second group extends outwardly on the second lateral side of the chainring. Thus, all teeth are of the same width, but each tooth is arranged in a laterally offset or staggered position relative to its neighboring teeth. The invention provides chainring teeth that offer the retention advantages of the Narrow-Wide technology (in terms of using width), but also allow the chain to engage with the chainring at multiple orientations. The invention provides a chainring that is not restricted by wide and arrow teeth on inner or outer link positions, and is not restricted to only even numbers of teeth.

### DESCRIPTION OF THE DRAWINGS

FIG. 1 is a right side perspective view of an embodiment of a chainring of the invention installed in a bicycle crankset, with a segment of roller chain engaged on the chainring.

FIG. 2 is a side perspective view of a segment of a conventional roller chain.

FIG. 3 is a top view of a segment of the roller chain of FIG. 2.

FIG. 4 is a side view of a segment of the roller chain of FIG. 2.

FIG. 5 is a right side perspective view of an embodiment of a chainring of the invention.

FIG. 6 is an enlarged view of a portion of a periphery of the chainring as shown in FIG. 5.

FIG. 7 is a left side perspective view of the chainring of the invention

FIG. 8 is an enlarged view of a portion of a periphery of the chainring as shown in FIG. 7.

FIG. 9 is a right side view of the chainring of the invention.

FIG. 10 is a top view of the chainring of the invention.

FIG. 11 is a left side view of the chainring of the invention.

FIG. 12 is an enlarged view of a portion of the chainring as shown in FIG. 10.

FIG. 13 is a right side view of an embodiment of the chain drive of the invention, with an outer link of the drive chain making initial engagement with a “wide right” tooth.

FIG. 14 is a top view of the chain drive of FIG. 13.

FIG. 15 is an enlarged view of a portion of the chain drive as shown in FIG. 14.

FIG. 16 is right side view of an embodiment of the chain drive of the invention, with an outer link of the drive chain making initial engagement with a “wide left” tooth.

FIG. 17 is a schematic representation comparing a Narrow-Wide chainring to an embodiment of the chainring of the invention.

FIG. 18 is a schematic representation comparing a Narrow-Wide chainring to an embodiment of the chainring of the invention, each with a roller chain engaged thereon.

FIG. 19 is a right side perspective view of an embodiment of a chainring of the invention.

FIG. 20 is an enlarged view of a portion of a periphery of the chainring as shown in FIG. 19.

The drawings illustrate exemplary embodiments for carrying out the invention. Like reference numerals refer to like parts in different views or embodiments of the present invention in the drawings.

### DETAILED DESCRIPTION

It is noted that, throughout this specification and claims, the terms “right” as compared to “left”, a “first” side as compared to a “second” side, or “one” side as compared to the “opposite” side, are all used interchangeably and without limitation. In general herein, a right side of a bicycle will be considered to be the side that is on the right side of a forward-facing rider of the bicycle, the right side being the right lateral side of a vertical plane extending along a central longitudinal axis of the bicycle. To aid explanation of the invention, a number of the drawing figures identify a “right” side of the chainring identified by reference numeral 1R and an opposite “left” side identified by reference numeral 1L.

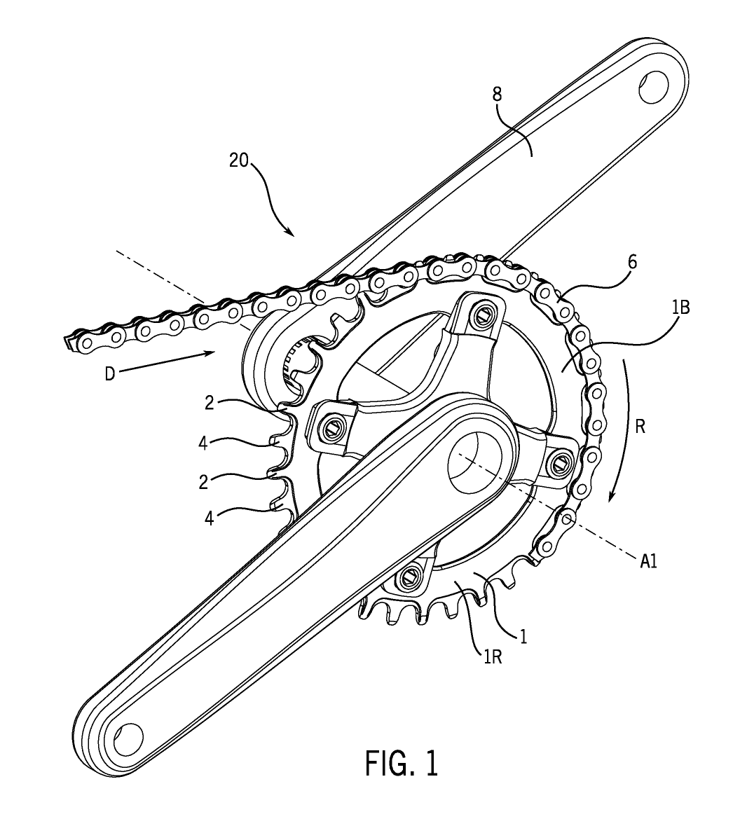

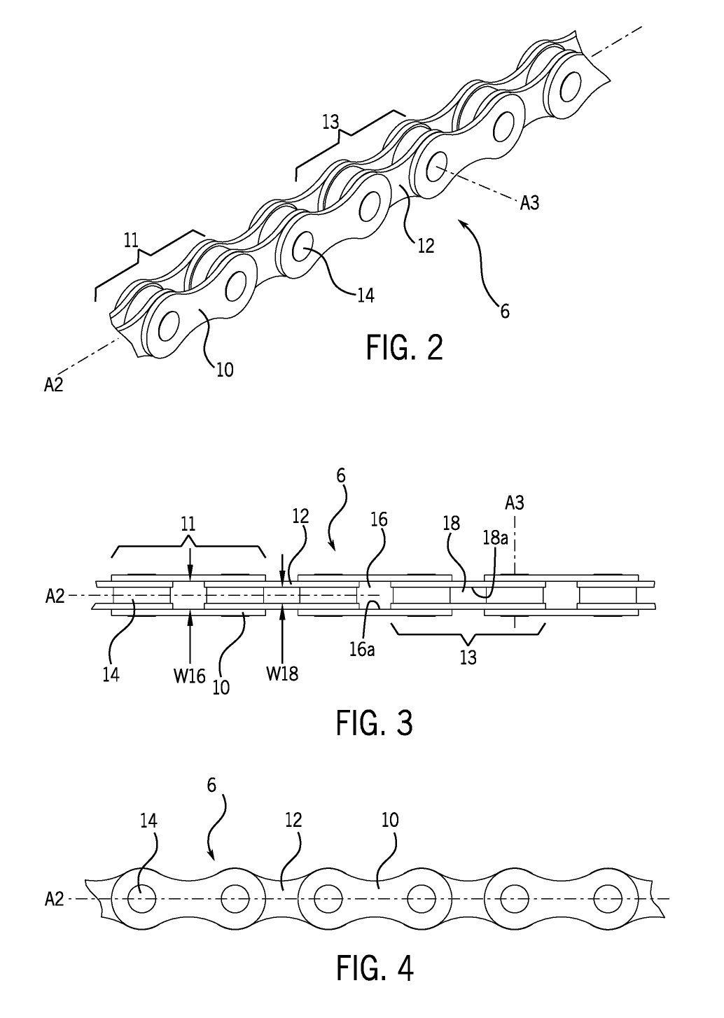

As seen in FIG. 1, a chainring 1 is installed as a part of a crankset 20 of a bicycle (not shown). The crankset 20 includes cranks 8 attached directly or indirectly to the chainring 1. The cranks 8 are adapted to be affixed to pedals (not shown) that are to be pressed downwardly by a rider so as to cause the cranks 8 along with the attached chainring 1 to rotate about a central axis of rotation of the chainring 1, the axis of rotation shown as line A1 in FIG. 1. Thereby, forward motion of the bicycle is caused as the chain 6 is pulled in a direction D along its longitudinal axis A2 (shown in FIG. 2). The chain 6 pulled in direction D is engaged to turn a sprocket of a wheel of a bicycle and thereby cause the wheel to turn. The direction of rotation of the chainring 1 during forward motion of the bicycle due to the pedaling is shown as line R in FIG. 1.

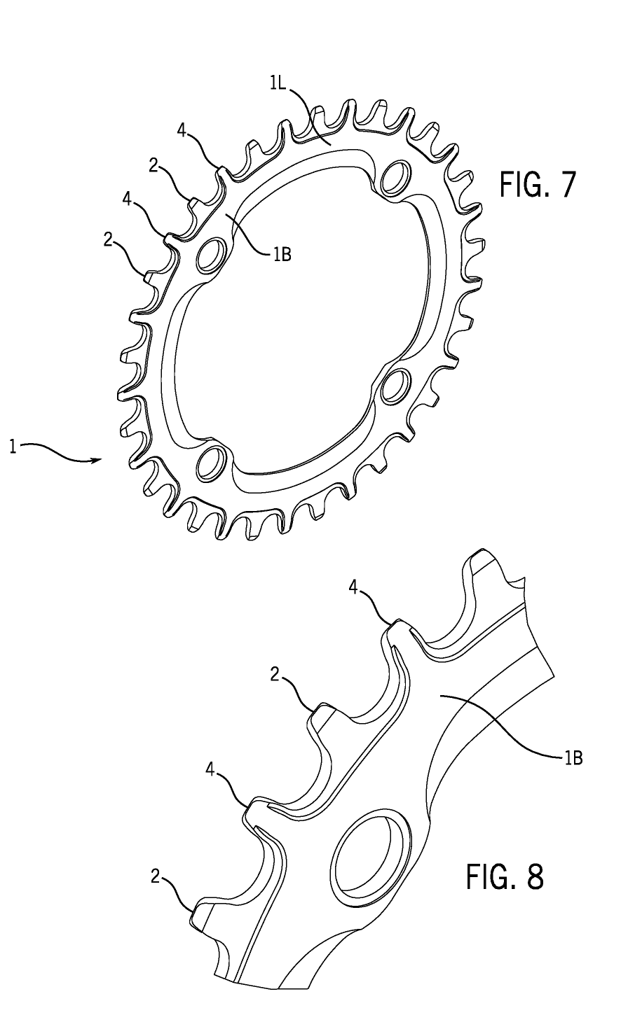

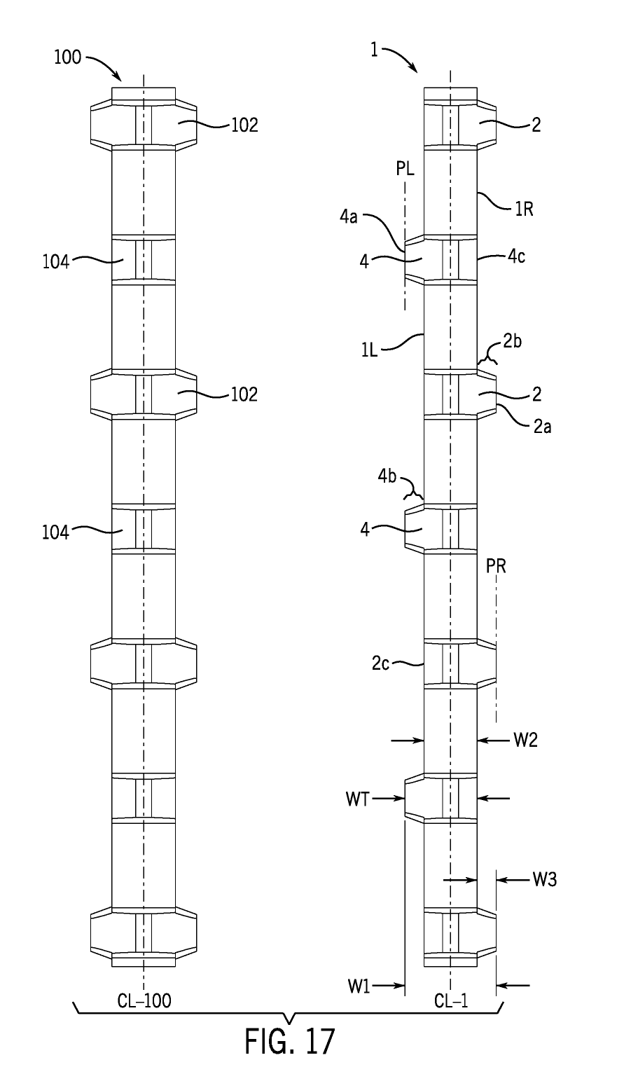

The chainring 1 is generally in the form of a flat disc that may have an open central region. As depicted in FIG. 1, the open central region may be surrounded by a chainring body 1B that may be adapted to be connected to parts of a crankset 8, such that the chainring 1 is positioned to rotate around a central axis of rotation A1 of the chainring 1 when the crankset 8 is operated by the pedaling rider. The chainring 1 has formed around the outer periphery of the chainring body 1B a plurality of teeth 2, 4 that all extend radially outwardly from the body 1B. FIG. 1 shows the chainring 1 from the right side, and the reference numeral 1R identifies the right lateral surface or right side wall of the chainring 1. The reference numerals 2, 2 identify a first set of teeth that have at least a portion of each tooth that is positioned on a first lateral or right side 1R of the chainring 1 relative to a central plane of the chainring, extending along the radial direction of the disc or body 1B. The reference numerals 4, 4 identify a second set of teeth that have at least a portion of each tooth that is positioned on the opposite side, namely on a second lateral or left side 1L of the chainring 1 relative to the central plane of the chainring. Left side 1L is shown in FIG. 7. The central plane of the chainring is shown as CL-1 in FIG. 17.

In operation of the chain drive, the chainring 1 engages with a conventional roller chain 6, depicted in FIGS. 2-4. As seen in FIG. 2, the roller chain 6 generally is formed of a series of outer links 11 and inner links 13. Each outer link 11 is formed by a pair of outer plates 10, 10, and each inner link 13 is formed by a pair of inner plates 12, 12. The outer links 11 are arranged with the inner links 13 in an alternating pattern 11:13:11:13 along the length of the longitudinal axis A2 of the chain 6. In a known arrangement, the plates are held together in each link in a spaced-apart position by pins 14, 14 as seen in FIGS. 2-4. The pins 14 are articulately connected to the plates 10, 12 such that the inner plates and outer plates can rotate relatively to each other, partially around a central longitudinal axis A3 of the pins 14 to which they are connected. Typically, rollers surround the pins coaxially along axis A3 and form the fore and aft abutting surfaces of the central gap of each link, but for the purposes of this discussion, no distinction is made between the pins 14 and their surrounding rollers.

As best seen in FIG. 3, inner plates 12, 12 are arranged closer to the central longitudinal axis A2 of the chain 6 than the outer plates 10, 10. In a given link, a pair of inner plates 12, 12 are sandwiched or interleaved between a pair of outer plates 10, 10, with a roughly quadrilateral space or gap being defined on the lateral sides by the inner or interior side walls of the respective plates positioned on each lateral side of the gap, and on the fore and aft sides by the outer walls of the pin and roller combinations 14, 14 that form the front and rear abutting surfaces of each gap.

An inner link 13 has an inner link space or gap 18. Reference numeral 18a identifies the interior side wall of an inner gap 18, which is the inside wall of an inner plate 12. An outer link 11 has an outer link space or gap 16. Reference numeral 16a identifies the interior side wall of an outer gap 16, which is the inside wall of an outer plate 10.

Inner link gap 18 has a narrower width W18 measured perpendicularly to the central longitudinal axis A2 of the chain 6 than the width of its adjacent outer link gap 16, which has a wider width W16 measured perpendicularly to the longitudinal axis A2. During operation of the chain drive system, each one of the inner link gaps 18 and the outer link gaps 16 will have fitted into it a tooth of the chainring 1. A conventional bicycle roller chain and a chain drive system employing such a chain are more fully described in Reiter et al., U.S. Patent Application Publication No. US 2013/0139642 A1 published Jun. 6, 2013, the entire disclosure of which is incorporated by reference herein.

The inventors herein have discovered an improved arrangement of the tooth features in a chainring 1, in which each tooth has a “wide” side, but the wide side alternates from one side to the opposite side in each adjacent tooth. This arrangement offers a simple and elegant improvement that avoids restrictions imposed by prior art Narrow-Wide chainrings. The improvements include better wear-resistance and improved cost-effectiveness due to the removal of restrictions on which tooth can fit into which chain gap, as experienced with Narrow-Wide chainrings. The improved design herein also offers improved chain retention as compared to traditional chainrings.

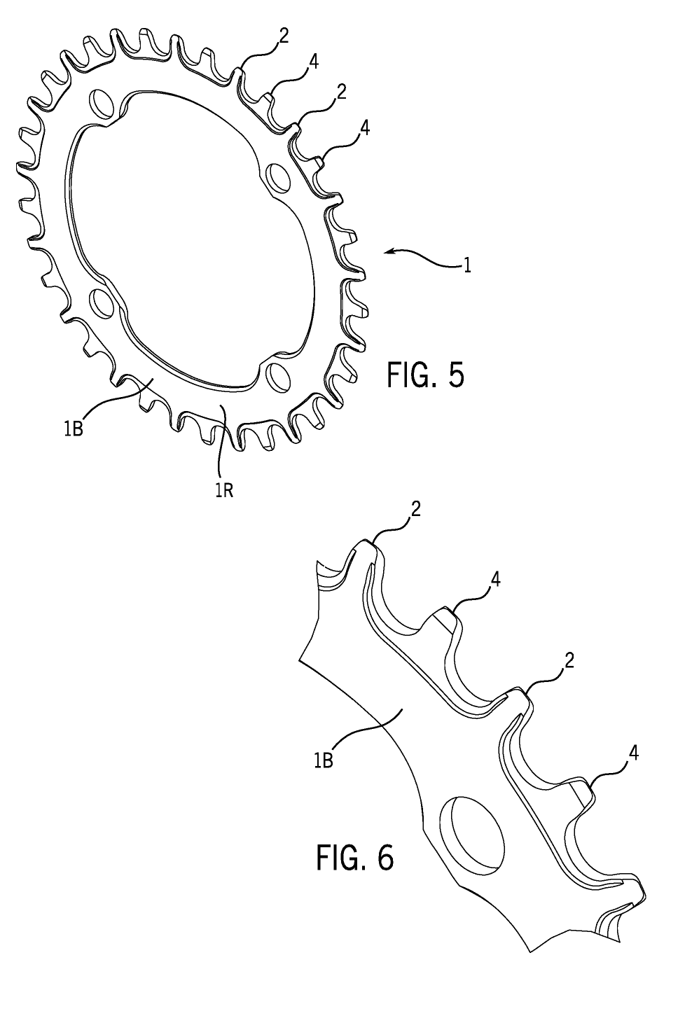

As seen in FIGS. 5-6, in the preferred configuration there is a first tooth 2 extending outwardly in a radially outward direction from the chainring body 1B, having a laterally extending projection or portion that is formed on one lateral side of the chainring 1, adjacent to the next tooth 4 having a laterally extending portion formed on the opposite lateral side of the chainring 1. FIG. 5 is a right side perspective view of the chainring 1 of the invention, showing in closer detail the arrangement of the teeth 2, 4 in an exemplary embodiment. The plurality of teeth includes the first group of teeth 2, 2, and the second group of teeth 4, 4. The plurality of teeth is arranged in a row. The teeth of the second group are arranged between the teeth of the first group around the circumference of the body 1B of the chainring 1 in a serially alternating pattern reflected by the sequence 2:4:2:4:2:4. A portion of each tooth of the first group extends outwardly on a first lateral side of the chainring, and a portion of each tooth of the second group extends outwardly on a second lateral side of the chainring, so the pattern is expressed as, for example, wide right, wide left, wide right, wide left, and so forth. As shown in the FIG. 5 view of the right side 1R of the chainring 1, the teeth 2, 2 have a “wide right side” on right side 1R while the teeth 4, 4 have a “wide left side” on the left side 1L of the ring 1.

An enlarged view of a portion of the periphery of the chainring 1 of FIG. 5 is shown in FIG. 6. As can be seen in the exemplary view of FIG. 6, the first group of teeth 2, 2 have their “wide” side on the right side of the chainring 1. The wide side of the tooth 2 can be formed by a number of known formations. In this exemplary view, the “wide” side is formed by a built-up portion of each tooth of the first group 2, 2 such that a flange or projection or thickened area extends slightly laterally outwardly on the right side 1R of the chainring 1. This lateral built-up portion forms an extension on a right lateral side 1R of the chainring 1 relative to a plane formed along a radial axis of the main body 1B of the chainring 1, that plane being generally perpendicular to the axis of rotation Al around which the chainring 1 spins during operation. The extension or projection on each tooth 2, 2 can be in any of a number of known shapes preferred in known chainring teeth, with a preferable shape or form intended to aid the shifting operation by providing preferred angles for the chain to be slipped off the tooth during a shift. The extended portion or projection formed on one side of each and every tooth 2, 4 of the present invention can generally be formed in a shape consistent with extended portion features typically found on both sides of a “Wide” tooth on a Narrow-Wide chainring. The teeth can be formed by known means, such as joining (e.g., welding) onto the main body 1B the laterally projecting portions of the teeth, or such as cutting away portions of the teeth such that the remaining portions form the laterally extending projections. The projecting portion generally is formed of the same material as the body 1B of the chainring 1.

FIGS. 7-8 show corresponding views to FIGS. 5-6, but show the opposite (left) side of the chainring 1. As can be seen by comparing FIGS. 5-6 to FIGS. 7-8, on the left lateral side 1L of the chainring 1, the second set of teeth 4, 4 have their “wide” side. In all other aspects of the teeth, the structure of the “wide left” teeth 4, 4 generally corresponds as a mirror image to the structure of the “wide right” teeth 2, 2 described above.

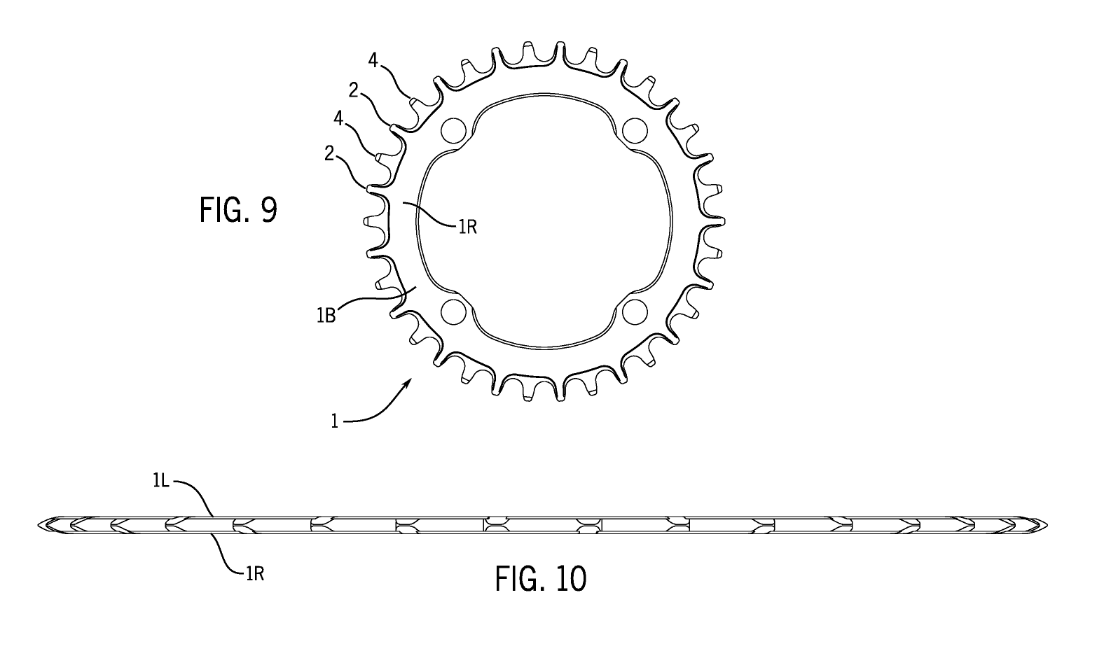

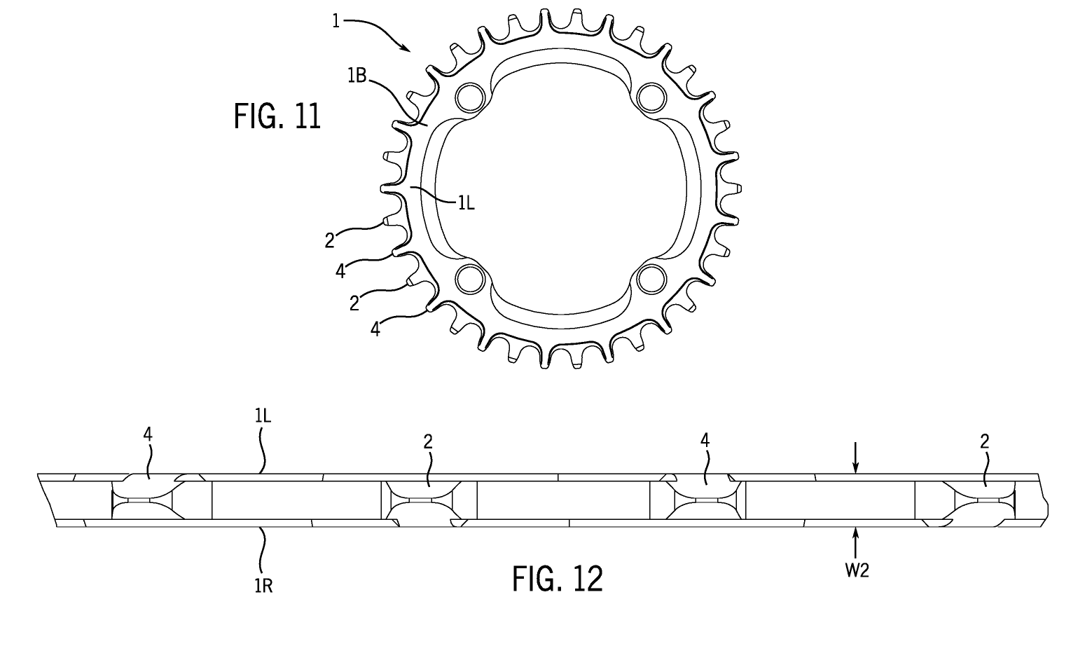

FIG. 9 shows a right side view of the chainring 1. FIG. 10 shows a top view (edge view) of the chainring 1. FIG. 11 shows a left side view of the chainring 1. It is apparent from FIGS. 9 and 11 that, in this embodiment as depicted, the total number of teeth 2, 4 is an even number. The teeth are arranged around the periphery of the chainring body 1B in an alternating pattern of 2:4:2:4:2:4. FIG. 12 is a close-up view of a portion of the chainring as shown in FIG. 10, illustrating in closer detail the contours of the tips of the teeth in a preferred embodiment of the invention.

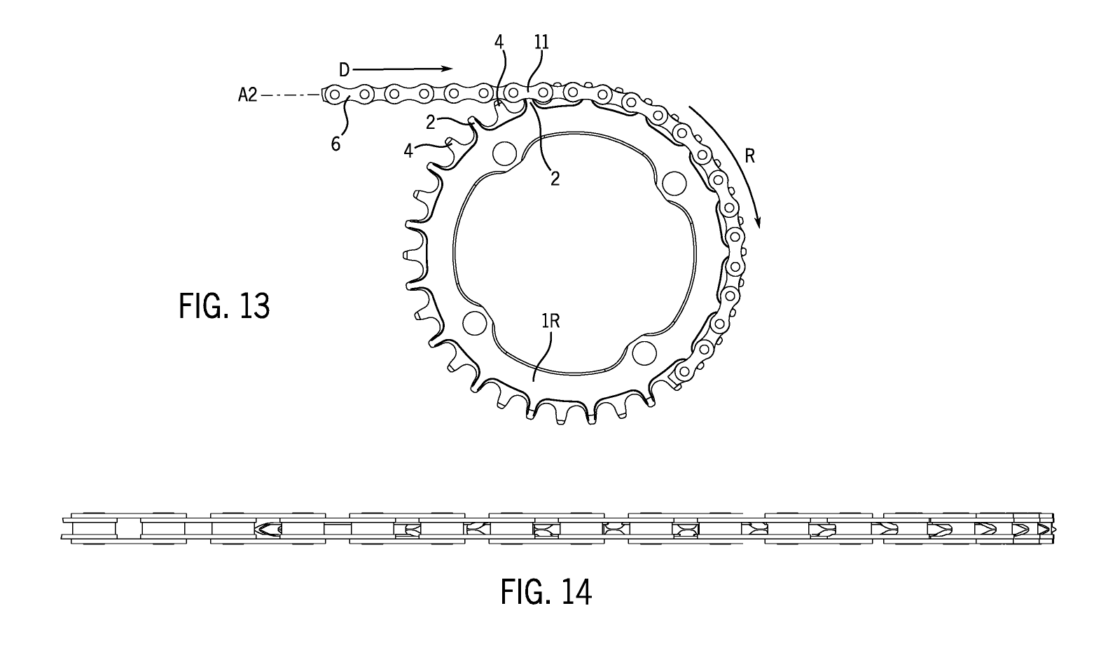

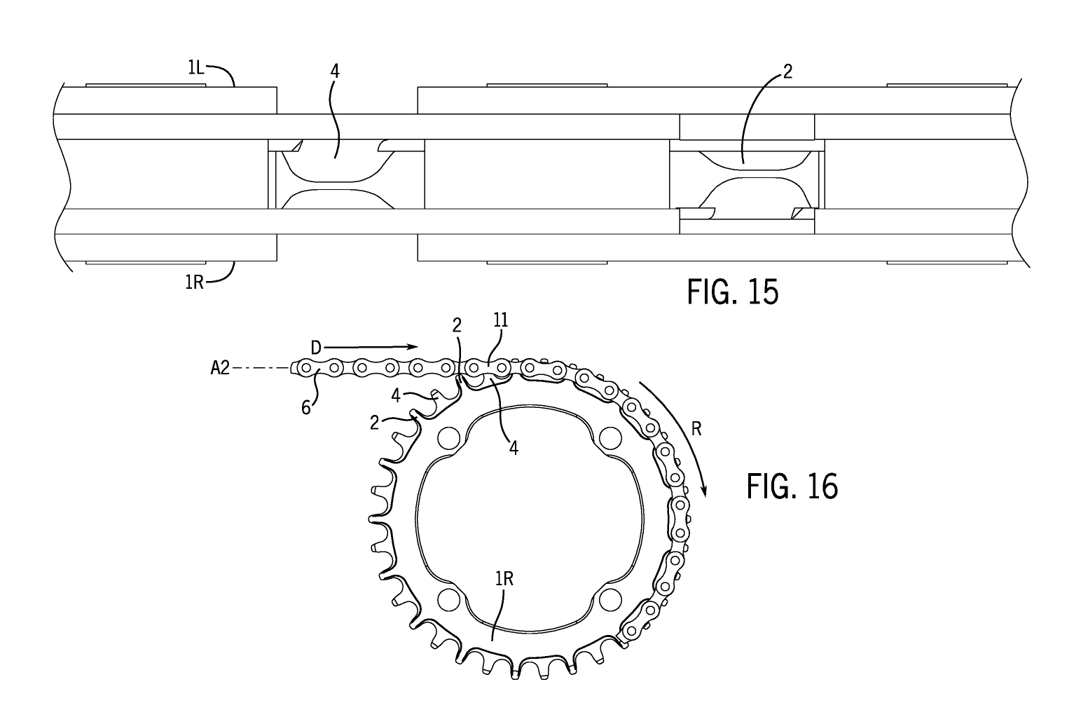

FIGS. 13 and 16 each show a right side view of the chain drive with a preferred embodiment of chainring 1 with a segment of conventional roller chain 6 engaged thereon. FIG. 14 provides a top view of the chainring 1 of the invention with a segment of roller chain 6 engaged thereon. FIG. 15 shows an enlarged view of a portion of the chainring 1 with the chain 6 engaged thereon, as shown in FIG. 14.

Comparison of FIG. 13 with FIG. 16 illustrates unique benefits offered by the novel configuration of a preferred embodiment. In FIG. 13, the chain 6 is being pulled forward along its longitudinal axis A2 in the direction indicated by arrow D, by rotation of the chainring 1 in the direction indicated by arrow R. The chain 6 is making initial engagement with a “wide right” tooth 2. The wide right tooth 2 is shown about halfway inserted into the outer link gap 16 of an outer link 11 of the chain 6. In contrast, FIG. 16 shows that the chainring 1 also can make an initial engagement with a “wide left” tooth 4 being inserted into one of the outer link gaps 16 of an outer link 11 the chain 6. It can thus be appreciated from contrasting FIG. 13 to FIG. 16 that, unlike prior Narrow-Wide configurations, the chain 6 may fit over the teeth 2, 4 in any orientation; regardless of whether a link aligned to engage with a particular tooth is an outer link 11 or an inner link 13, any wide right tooth 2 as well as any wide left tooth 4 will fit into that link. The configuration discovered by the inventors allows any given tooth to act as a “wide” tooth when it is fitted into an outer link gap 16 of the chain 6, but also to act as a “narrow” tooth when fitted into an inner link space 18.

In one preferred embodiment of the chainring and chain drive system, the configuration is restricted to and consists of the chainring 1 having a total number of teeth that is restricted to and consists of an even number of teeth, all of equal width, and with a portion of each tooth 2 of the first group extending outwardly on a first lateral side of the chainring, and a portion of each tooth 4 of the second group extending outwardly on a second lateral side of the chainring 1, in the described pattern 2:4:2:4:2:4 along the periphery of the chainring 1. This embodiment provides a preferred benefit of flexibility wherein any one of the teeth, whether a “wide right” tooth 2 or a “wide left” tooth 4, can be inserted into one of the narrower inner gaps 18 of the chain 6.

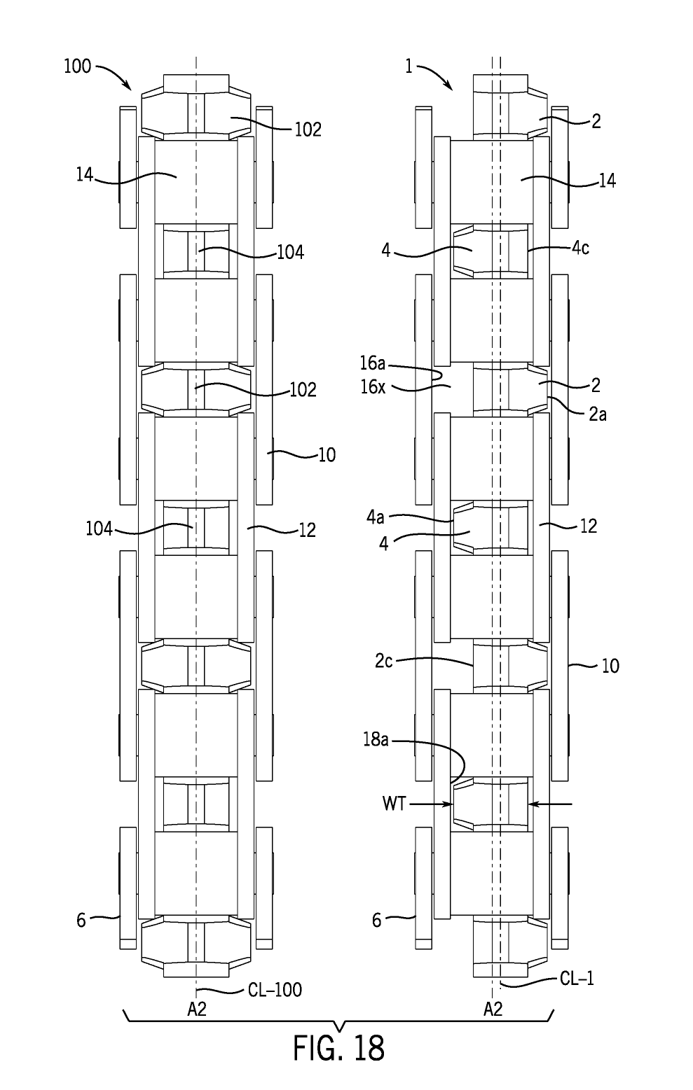

In another preferred embodiment, a chainring 1 of a chain drive system of the present invention can have any number of teeth, including an odd number of teeth, by adding in an extra “narrow” tooth for transition. This additional narrow tooth N (not shown) would have no wide side, i.e., it would be centered on the central plane of the chainring 1, and would not have a lateral projection, extension, or protrusion on either lateral side of the chainring. This additional, narrow tooth N thus would have a construction similar to a narrow tooth 104 of the Narrow-Wide chainring 100 depicted in FIGS. 17 and 18.

Insertion of this extra tooth N in the sequence may yield a tooth pattern along the periphery of the chainring 1 of, for example, 2:4:2:N:4:2:4. In another preferred embodiment, the chainring 1 may be further restricted in design such that the number of teeth is restricted to or consists of an odd number of teeth, with an even total number of “wide right” teeth 2 and “wide left” teeth 4, all having the same width, and positioned in an alternating one-to-one pattern of 2:4:2:4:2:4 around the periphery of the ring 1, with the addition of one single extra “narrow” tooth N added in to the row of teeth of the chainring, the teeth alternating as described above to result in the pattern 2:4:2:N:4:2:4 or 2:4:2:N:2:4:2 around the periphery. In contrast, in prior art Narrow-Wide constructions, the chainring tooth count must be an even number. This is because every other tooth is a “wide” tooth, and every other chain link is a narrower inner link 13 having a narrower inner gap 18, and the “wide” teeth cannot fit into inner gaps 18; the wide teeth can fit only into the wider outer link gaps 16 of the chain 6.

Benefits of the configuration of the chainring and chain drive of the invention are further illustrated by the graphic representations shown in FIGS. 17-18. It is noted that the representations are not to scale and portions may be exaggerated in size or shifted in relative position to better illustrate structural and operational features of the chainring and chain drive system.

In FIG. 17, there are shown schematic representations of top (edge) views of each of a chainring 1 of the invention shown on the right side and a known Narrow-Wide chainring 100 shown on the left side. FIG. 18 shows the same schematic representations of chainring 1 and Narrow-Wide chainring 100 as illustrated in FIG. 17, with the addition of conventional chains 6, 6 engaged thereon in a chain drive system.

As best seen in FIG. 17, the Narrow-Wide chainring 100 has a wide portion on both sides of every other tooth. These wide teeth 102, 102 of chainring 100 are arranged with the narrow teeth 104, 104 interposed therebetween in a regular alternating pattern of 102:104:102:104:102:104, and so forth, all around the circumference of the edge of the chainring 100. Each wide tooth 102 is wider than each narrow tooth 104. Each wide tooth 102 can fit only into the wider gaps 16 existing inside the outer links 11 of the chain 6; each wide tooth 102 is too wide to be inserted into the narrower gaps 18 existing within the inner links 13 (see FIG. 3). The line CL-100 represents the position of the central plane of the Narrow-Wide chainring 100. The central longitudinal axis in a height direction of each tooth 102, 104 is centered on the central plane represented by CL-100, regardless of whether the tooth is a wide tooth 102 or a narrow tooth 104.

As seen in FIG. 17, in contrast to the Narrow-Wide construction, the chainring 1 of the invention herein has a widened portion of each tooth, but has this widened portion formed on only one lateral side of each tooth—essentially forming a zig-zag pattern along the length of the chainring periphery. This zig-zag pattern allows the teeth of the chainring 1 to engage with the chain 6 regardless of whether a particular tooth 2 or 4 is positioned to be inserted into a wider outer link gap 16 having width W16, or a narrower inner link gap 18 having width W18 (see FIG. 3). Any tooth 2 or 4 can be received in any one of the gaps or spaces 16 or 18. The geometry of the claimed configuration accomplishes nearly the same tracking benefits of the known Narrow-Wide configuration, but the engagement of the claimed chainring 1 with the chain 6 is not as limited because any tooth 2 or 4 can be inserted into any gap 16 or 18 along the length of the chain 6.

As depicted in FIG. 17, a Narrow-Wide chainring 100 has an axis or center line CL-100, and the chainring 1 of the present invention has an axis or center line CL-1. Each such center line CL-100 or CL-1 represents the position of the central plane of the ring, the plane extending in the direction of a radial axis of the chainring, and thus, extending in a direction generally perpendicular to the axis of rotation Al around which the chainring rotates during operation. In an embodiment of chainring 1 as shown in FIG. 17, there may be a distance or width W1 defined between the outermost lateral side surface 2a of a tooth 2 on the ring's right side 1R and the outermost lateral side surface 4a of the next adjacent tooth 4 on the ring's opposite (left) side 1L. In an embodiment, one-half of the width W1 may be disposed on each of the two lateral sides of center line CL-1, such that the two outermost surfaces 2a and 4a (i.e., the two endpoints of the line defining the width W1) may be approximately equidistant from the center line CL-1. As shown in FIG. 17, the distance or width W2 may represent a width of a base of a tooth. W3 may represent a width of the lateral side projection of a given tooth, that is to say, the distance W3 that the tooth's projection extends beyond that side's endpoint of the tooth base width W2. In preferred embodiments, W2 may be equal for every tooth. In preferred embodiments, W3 may be equal in every tooth.

The feature as described herein where, in a preferred arrangement, any chainring tooth 2 or 4 can be inserted into any chain gap 16 or 18, is similar to traditional chainrings that do not have the wide or narrow sides of a Narrow-Wide chainring 100. Additionally, traditional chainrings have teeth that are substantially the same width or thickness from tooth to tooth. An embodiment of the present invention differs from traditional chainrings by having offsetting wide sides where, as shown in FIG. 17, the total distance or width W1 between the outermost lateral side surface 2a of a tooth 2 on a first side of the ring 1 and the outermost lateral side surface 4a of its adjacent tooth 4 on the opposite side of the ring 1 may preferably be greater than the width WT of an individual tooth 2 or 4. In a preferred embodiment, the any given tooth 2 or 4 is not centered upon and does not have a central longitudinal axis in the height direction that is aligned with the central plane CL-1 of the chainring 1; instead, the central longitudinal axis in the height direction of the tooth is offset from the central plane CL-1, either on the left or right side depending on whether the tooth is a first group tooth 2 or a second group tooth 4. In chainring 1 as illustrated, the total distance

W1 between the outer lateral side surfaces of a given tooth and that of its next adjoining tooth in the row may be greater than the width WT of any tooth 2 or 4 because of the alternating protrusions 2b and 4b positioned on opposite lateral sides of the ring. In a traditional chainring, the distance between outer lateral side surfaces of a given tooth and its next adjoining tooth generally is the same as the width of any tooth.

A preferred embodiment of the present invention also differs from traditional chainring drive train systems by having offsetting wide sides where the total distance or width W1 between the opposite outermost lateral side surfaces 2a and 4a of two adjoining teeth 2 and 4 is greater than the lateral width W18 of the gap 18 that is created between plates 12, 12 of the inner link 13 of the chain 6. In contrast, traditional chainrings have a total distance or width between the opposite outermost lateral side surfaces of two adjoining teeth that is not greater than the lateral width W18 of the gap 18.

Additionally, teeth of a traditional chainring share width boundaries in a single plane, unlike the embodiment of the invention as illustrated in FIG. 17. In a chainring 1 of the embodiment, a plane identified by line PR in FIG. 17 is positioned on a first lateral side of the central plane CL-1, and is parallel to the central plane identified by line CL-1 of chainring 1. Plane PR is defined along a line connecting the respective outermost lateral side surfaces 2a, 2a of the first group of teeth, 2, 2 (also called the outer side tooth walls of the first group of teeth 2, 2, which are wide right teeth). Another plane PL is positioned on the second lateral side of the central plane CL-1, also parallel to the central plane CL-1. Plane PL is defined along a line connecting the respective outermost lateral side surfaces 4a, 4a of the second group of teeth 4, 4 (also called the outer side tooth walls of teeth 4, 4, which are wide left teeth). Planes PR and PL differ from: (a) a plane defined along a line drawn between the inner side tooth walls 2c and 2c on the left side; and (b) a plane defined along a line drawn between the inner side tooth walls 4c and 4c on the right side. These two planes (2c-2c and 4c-4c) are not shown in FIG. 17 but would be positioned along the two boundary lines of the distance W2 shown on ring 1 in FIG. 17 (to which the two arrows defining W2 point). Thus in this particular embodiment, planes PR, PL, 2c-2c, and 4c-4c are not in the same plane. This differs from a traditional chainring wherein generally plane PR would be coplanar with plane 4c-4c, and plane PL would be coplanar with 2c-2c.

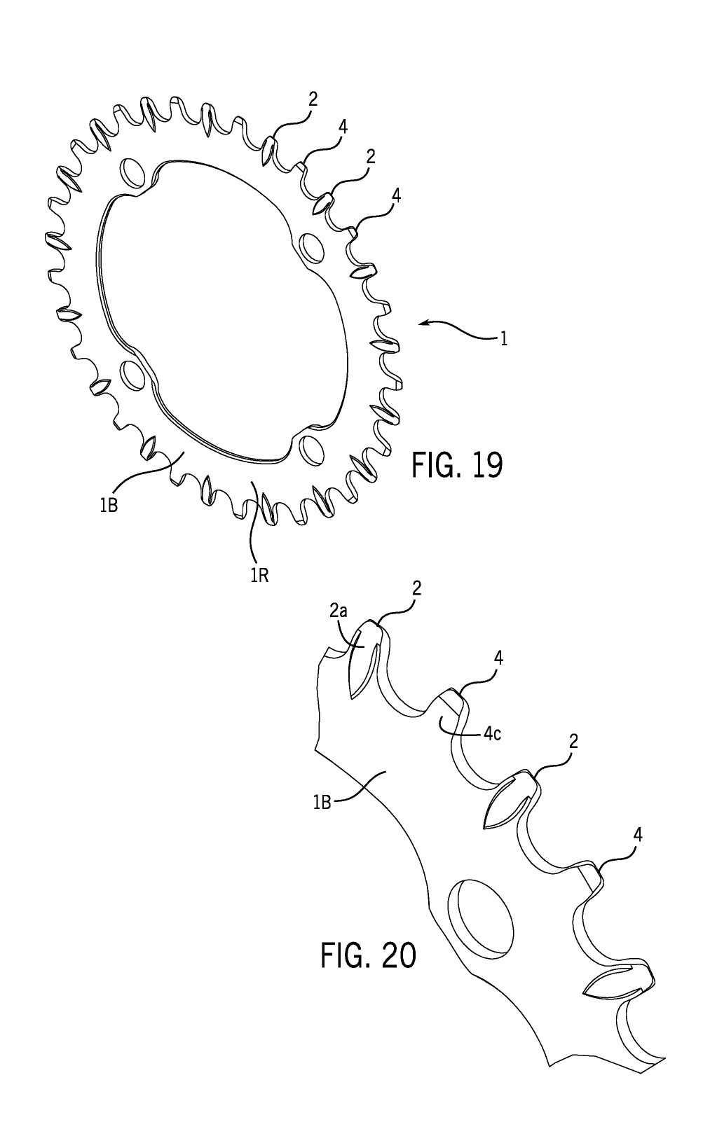

It is noted that the schematic views of FIGS. 17 and 18 are representational only. The representations are not restricted as to how far the outwardly laterally extending portions 2b and 4b protrude. FIGS. 19 and 20 show an embodiment wherein the laterally extending portions 2b, 2b of the first group teeth 2, 2, and the laterally extending portions 4b, 4b of the second group teeth 4, 4, all protrude laterally outwardly far enough to extend beyond the chainring side walls on their respective sides of the ring. FIG. 20 shows outermost surface 2a of the projection 2b projecting outwardly far enough to extend beyond the right lateral side wall 1R of the chainring body 1B. Although not shown, outermost surface 4a of the projection 4b on the opposite side also projects outwardly beyond its respective chainring side wall 1L.

Because of the construction of the chainring 1 embodiment as illustrated in FIGS. 17-18, the chainline, a center line of the chain along its central longitudinal axis A2, will be offset slightly in an axial direction on each link, depending on how the chain is oriented on the tooth. This is in contrast to the Narrow-Wide construction shown in chainring 100 in FIG. 18. In this Narrow-Wide construction, the centerline or longitudinal axis A2 of the chain 6 is aligned with the central plane CL-100 of the Narrow-Wide chainring 100 in a coplanar or coaxial relationship. That alignment of chain axis A2 with the central plane would also be present in a chain drive using a traditional chainring. The FIG. 18 illustration of the chain drive of the invention shows that the axis A2 of the chain 6 is not aligned with the central plane CL-1 of ring 1. CL-1 is offset slightly in the lateral direction, in this case to the right because the wide right teeth 2, 2 are currently engaged in the outer gaps 16, 16, and the wide left teeth 4, 4 are engaged in the inner gaps 18, 18. If instead the wide right teeth 2, 2 were engaged in the inner gaps 18, 18, then plane CL-1 would be offset slightly to the left side of A2. It is noted that the engagement of the wide right tooth 2 in an outer gap 16 leaves an open space 16x in the opposite one of the two side portions or recesses in the outer link gap 16. Each of such side portions or side recesses in the outer link gap 16 is space existing within the gap 16, with a rear end of the preceding inner link plate 12 forming its forward boundary, and a front end of the following inner link plate 12 forming its rearward boundary. For example, in FIG. 18, the recess 16x is shown opposite to its corresponding recess on the opposite side, which is shown filled with the projecting portion 2b of tooth 2 ending in face 2a).

Because any tooth 2, 4 of the chainring 1 can be inserted into any space 16, 18, the chainring 1 can be used in bicycles adapted for shifting of gears. In an exemplary bicycle shifting mechanism, two chainrings (i.e., two gears) of different diameters may be installed in a crankset 20, and the chain 6 is shifted between the two chainrings by a derailleur. A chainring used in a shifting system must accept the chain 6 as it falls, or is pushed onto it, by the derailleur. The chain 6 must engage as quickly and smoothly as possible onto the next gear. That is not possible with Narrow-Wide chainrings 100, because the chain 6 can fall into positions that the chainring teeth are not able to accept, i.e., a wide tooth 102 might be aligned with, but be unable to fit into, a (narrower) inner link space 18 due to its wide width.

As described earlier, a chainring of the present invention can have any number of teeth, including odd numbers of teeth, by adding in an extra “narrow both sides” tooth N, for transition. Narrow-Wide constructions can have only an even number of teeth, because, by construction, every other chain link is a “wide” or outer link 11, and every link interposed between two outer links 11, 11 is a “narrow” or inner link 13, and accordingly the links have the repeating pattern of 11:13:11:13:11:13. To meet this repeating pattern of the chain 6, the Narrow-Wide chainrings must follow this pattern and thus are restricted to even numbers of teeth. In this embodiment of the invention, the extra tooth N would have no wide side, i.e., it would not have a lateral projection on either lateral side of the chainring, and so would preferably be similar in position and construction to a center-aligned narrow tooth 104 of the Narrow-Wide chainring 100 as shown in FIG. 17. This single full-narrow tooth N can transition from wide right to wide left, depending on whether its neighboring teeth are engaged in outer links 11, 11 or inner links 13, 13.

The chainring 1 of the present invention has one wide side on each tooth, but neighboring teeth alternate wide sides (left and right). Each one of the teeth 2, 2 in the first group preferably has the same or similar total width, measured at the thickest portion of the respective tooth 2. In a preferred embodiment, the widest dimension along the radial plane of the chainring 1, measured as the distance between the outer edges of the respective wide sides of the chainring 1 (see width W1 in FIG. 17) is larger than that that of a traditional, full-narrow chainring, relative to a given width of chain 6. However, the width W1 is not as wide as a typical prior art Narrow-Wide chainring at its widest dimension, relative to that same given width chain 6. Because of the wider width W1 as compared to that of traditional chainrings, and because the wider teeth 2, 4 of the claimed chainring 1 have projections 2b and 4b with side walls 2a and 4a that extend farther in laterally into the side recesses of the gaps 16 of the outer links 11 as compared to teeth of traditional chainrings, the claimed invention provides nearly all of the added tracking and retention benefits of Narrow-Wide chainrings, without the orientation and positioning problems caused by the prior art Narrow-Wide configuration. The chainring 1 of the present invention also has the ability to be used as a shifting ring, because the ring does not require a particular orientation with respect to outer links 11 and inner links 13, as does the prior art Narrow-Wide configuration.

To accomplish these ends, disclosed is an embodiment of a chainring of a bicycle for engaging a bicycle drive chain having inner links and outer links, the chainring comprising a plurality of teeth formed about a periphery of the chainring, wherein the plurality of teeth includes a first group of teeth, and a second group of teeth, wherein the teeth of the second group are arranged alternatingly between the teeth of the first group; each tooth has the same tooth width; a portion of each tooth of the first group extends outwardly on a first lateral side of the chainring; and a portion of each tooth of the second group extends outwardly on a second lateral side of the chainring.

To further accomplish these ends, disclosed is an embodiment of a chainring of a bicycle for engaging a bicycle drive chain having inner links and outer links, the chainring comprising a plurality of teeth formed about a periphery of the chainring, wherein the plurality of teeth includes a first group of teeth, and a second group of teeth, wherein the teeth of the second group are arranged alternatingly between the teeth of the first group; each tooth in the first group comprises a protrusion on a first lateral side of the chainring and is free of protrusions on a second lateral side of the chainring; and each tooth in the second group comprises a protrusion on the second lateral side of the chainring and is free of protrusions on the first lateral side of the chainring.

To further accomplish these ends, disclosed is an embodiment of a chainring of a bicycle for engaging a bicycle drive chain having inner links and outer links, the chainring comprising a plurality of teeth formed in a tooth row about a periphery of the chainring having a first lateral side and a second lateral side, wherein the plurality of teeth includes a first group of teeth, and a second group of teeth, wherein the teeth of the second group are arranged alternatingly between the teeth of the first group; each of the teeth comprises a first lateral side wall positioned on the first lateral side of the chainring and a second lateral side wall positioned on the second lateral side of the chainring; the first lateral side walls of the teeth of the first group define a series of projections in the row along the first lateral side of the chainring; and the second lateral side walls of the teeth of the second group define a series of projections in the row along the second lateral side of the chainring.

To further accomplish these ends, disclosed is an embodiment of a bicycle chain drive, comprising: a bicycle drive chain and a bicycle chainring, wherein the drive chain comprises pairs of opposed inner link plates and pairs of opposed outer link plates, and connecting pins connecting said pairs of link plates in an alternating, overlapping relationship, defining a series of inner links alternating with a series of outer links, said inner links formed by each pair of opposed inner link plates having an inner link gap between each pair of opposed inner link plates, and said outer links formed by each pair of opposed outer link plates having an outer link gap between each pair of opposed outer link plates; the chainring comprises a plurality of teeth formed about a periphery of the chainring; the plurality of teeth includes a first group of teeth, and a second group of teeth, wherein the teeth of the second group are arranged alternatingly between the teeth of the first group; each tooth has the same tooth width; each tooth comprises an inner side tooth wall and an outer side tooth wall; the outer side tooth wall of each tooth of the first group extends laterally outwardly on a first lateral side of the chainring; the outer side tooth wall of each tooth of the second group extends laterally outwardly on a second lateral side of the chainring; and in operation of the chain drive, a tooth of the first group is inserted into an outer link gap with the outer side tooth wall of the tooth engaging with an interior side wall of the outer link, and the inner side tooth wall of the tooth not engaging with an interior side wall of the outer link, and a tooth of the second group is inserted into an inner link gap with the inner side tooth wall and the outer side tooth wall of the tooth each engaging with one of the interior side walls of the inner link.

To further accomplish these ends, disclosed is an embodiment of a bicycle chain drive, comprising: a bicycle drive chain and a bicycle chainring, wherein the drive chain is constructed as described in the preceding paragraph; the chainring has a central plane perpendicular to an axis of rotation of the chainring, and comprises a plurality of teeth formed about a periphery of the chainring; the plurality of teeth includes a first group of teeth, and a second group of teeth, wherein the teeth of the second group are arranged alternatingly between the teeth of the first group; each tooth comprises an inner tooth side and an outer tooth side; the outer tooth side of each tooth of the first group extends laterally outwardly on a first lateral side of the chainring; the outer tooth side of each tooth of the second group extends laterally outwardly on a second lateral side of the chainring; and in operation of the chain drive, a tooth of the first group is inserted into an outer link gap, with the outer tooth side inserted into a side recess formed in the outer link gap, and the central longitudinal axis of the drive chain is offset from the central plane of the chainring.

Certain embodiments of the invention may include features of having the plurality of teeth further comprising a single narrow tooth that has a narrower width than the width of the teeth of the first group and of the second group, and the plurality of teeth comprising an odd number of teeth.

Certain embodiments of the invention may include features of having the outwardly extending portion of each tooth of the first group extending outwardly in a lateral direction beyond a chainring side wall on the first lateral side of the chainring; and the outwardly extending portion of each tooth of the second group extending outwardly in a lateral direction beyond a chainring side wall on the second lateral side of the chainring.

Certain embodiments of the invention may include features of chainring wherein the tooth width is a width that fills a lateral width of a gap inside the inner links of the drive chain, or wherein the tooth width is a width less than a lateral width of a gap inside the outer links of the drive chain.

Images used in this disclosure are of a specific size chainring of the invention, but the concepts contained herein can be translated to chainrings of nearly any size. In understanding the scope of the present invention, the term “configured” as used herein to describe a component, section or part of a device includes structural elements that are constructed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including,” “having,” and their derivatives. Also, the terms “part,” “section,” “portion,” “member,” or “element,” when used in the singular, can have the dual meaning of a single part or a plurality of parts that carries out the desired function of the single part in question. As used herein to describe the present invention, the following directional terms “forward,” “rearward,” “fore,” “aft,” “top,” “bottom,” “above,” “below,” “downward,” “vertical,” and “horizontal,” as well as any other similar directional terms refer to those directions of a bicycle equipped with the present invention. Accordingly, these terms, as utilized to describe the present invention should be interpreted relative to a bicycle equipped with the present invention, as used in the normal riding position by a rider normally seated in a forward-facing position on the bicycle. Finally, terms of degree such as “substantially,” “about” and “approximately” if used herein mean a reasonable amount of deviation of the modified term such that the end result is not significantly changed. “Engaged,” “engaging,” or “engages” “fitted into,” “seated” are intended to be used interchangeably herein and generally mean arranged or pressed into close contact with, closely abutting, operatively connected, or operatively fit into.

While the foregoing advantages of the present invention are manifested in the illustrated embodiments of the invention, a variety of changes can be made to the configuration, design and construction of the invention to achieve those advantages. Hence, reference herein to specific details of the structure and function of the present invention is by way of example only and not by way of limitation.

### LIST OF REFERENCE NUMERALS

1 chainring
Al axis of rotation of crankset
1B body of chainring
1R right lateral side (side wall) of chainring
1L left lateral side (side wall) of chainring
2 tooth of first group (a “wide right” tooth)
2a outer side tooth wall of tooth of first group (outermost lateral side surface of “wide right” tooth)
2b protruding portion of tooth of first group (width is W3)
2c inner side tooth wall of tooth of first group
4 tooth of second group (a “wide left” tooth)
4a outer side tooth wall of tooth of second group (outermost lateral side surface of “wide left” tooth)
4b protruding portion of tooth of second group (width is W3)
4c inner side tooth wall of tooth of second group
6 chain
A2 central longitudinal axis of drive chain
D direction of chain motion
8 crank
10 outer plate of chain
11 outer link of chain
12 inner plate of chain
13 inner link of chain
14 pin of chain
A3 axis of pin of chain
16 gap in an outer link
16a interior side wall of outer gap 16 (also is inside wall of outer plate 10)
16x open portion of gap 16 (side recess in gap 16 formed between fore and aft inner plates)
W16 width of gap between outer plates in an outer link
18 gap in an inner link
18a interior side wall of inner gap 18 (also is inside wall of inner plate 12)
W18 width of gap between inner plates in an inner link
20 crankset
100 Narrow-Wide chainring
102 wide tooth of Narrow-Wide chainring
104 narrow tooth of Narrow-Wide chainring
W1 width of chainring of the invention at its widest point
W2 width of tooth base
W3 width of lateral side projecting portion of tooth
WT width of tooth at point of engagement with interior side walls of inner gap 16
CL-1 center line showing position of central plane of chainring body
CL-100 center line showing position of central plane of prior art Narrow-Wide chainring body
PR line showing position of right side plane defined along surfaces 2a, 2a
PL line showing position of left side plane defined along surfaces 4a, 4a

1. A chainring of a bicycle for engaging a bicycle drive chain having inner links and outer links, the chainring comprising a plurality of teeth formed about a periphery of the chainring, wherein
the plurality of teeth includes a first group of teeth, and a second group of teeth, wherein the teeth of the second group are arranged alternatingly between the teeth of the first group;
each tooth has the same tooth width;
a portion of each tooth of the first group extends outwardly on a first lateral side of the chainring; and
a portion of each tooth of the second group extends outwardly on a second lateral side of the chainring.

2. The chainring according to claim 1, wherein
the plurality of teeth further comprises a single narrow tooth that has a narrower width than the width of the teeth of the first group and of the second group, and
the plurality of teeth comprises an odd number of teeth.

3. The chainring according to claim 1, wherein
the outwardly extending portion of each tooth of the first group extends outwardly in a lateral direction beyond a chainring side wall on the first lateral side of the chainring; and
the outwardly extending portion of each tooth of the second group extends outwardly in a lateral direction beyond a chainring side wall on the second lateral side of the chainring.

4. The chainring according to claim 1, wherein the tooth width is a width that fills a lateral width of a gap inside the inner links of the drive chain.

5. The chainring according to claim 4, wherein the tooth width is a width less than a lateral width of a gap inside the outer links of the drive chain.

6. A chainring of a bicycle for engaging a bicycle drive chain having inner links and outer links, the chainring comprising a plurality of teeth formed about a periphery of the chainring, wherein
the plurality of teeth includes a first group of teeth, and a second group of teeth, wherein the teeth of the second group are arranged alternatingly between the teeth of the first group;
each tooth in the first group comprises a protrusion on a first lateral side of the chainring and is free of protrusions on a second lateral side of the chainring; and
each tooth in the second group comprises a protrusion on the second lateral side of the chainring and is free of protrusions on the first lateral side of the chainring.

7. The chainring according to claim 6, wherein
the plurality of teeth further comprises a single narrow tooth that has a narrower width than a width of the teeth of the first group and of the second group, and
the plurality of teeth comprises an odd number of teeth.

8. The chainring according to claim 6, wherein the protrusions on the teeth of the first group extend beyond a chainring side wall on the first lateral side of the chainring, and
the protrusions on the teeth of the second group extend beyond a chainring side wall on the second lateral side of the chainring.

9. A chainring of a bicycle for engaging a bicycle drive chain having inner links and outer links, the chainring comprising a plurality of teeth formed in a tooth row about a periphery of the chainring having a first lateral side and a second lateral side, wherein
the plurality of teeth includes a first group of teeth, and a second group of teeth, wherein the teeth of the second group are arranged alternatingly between the teeth of the first group;
each of the teeth comprises a first lateral side wall positioned on the first lateral side of the chainring and a second lateral side wall positioned on the second lateral side of the chainring;
the first lateral side walls of the teeth of the first group define a series of projections in the row along the first lateral side of the chainring; and
the second lateral side walls of the teeth of the second group define a series of projections in the row along the second lateral side of the chainring.

10. The chainring according to claim 9, wherein
the plurality of teeth further comprises a single narrow tooth that has a narrower width than a width of the teeth of the first group and of the second group, and
the plurality of teeth comprises an odd number of teeth.

11. The chainring according to claim 9, wherein
the first lateral side walls of the teeth of the first group extend beyond a chainring side wall on the first lateral side of the chainring; and
the second lateral side walls of the teeth of the second group extend beyond a chainring side wall on the second lateral side of the chainring.

12. A bicycle chain drive, comprising:
a bicycle drive chain and a bicycle chainring, wherein
the drive chain comprises pairs of opposed inner link plates and pairs of opposed outer link plates, and connecting pins connecting said pairs of link plates in an alternating, overlapping relationship, defining a series of inner links alternating with a series of outer links centered along a central longitudinal axis of the drive chain, said inner links formed by each pair of opposed inner link plates having an inner link gap between each pair of opposed inner link plates, and said outer links formed by each pair of opposed outer link plates having an outer link gap between each pair of opposed outer link plates;
the chainring has a central plane perpendicular to an axis of rotation of the chainring, and comprises a plurality of teeth formed about a periphery of the chainring;
the plurality of teeth includes a first group of teeth, and a second group of teeth, wherein the teeth of the second group are arranged alternatingly between the teeth of the first group;
each tooth comprises an inner tooth side and an outer tooth side;
the outer tooth side of each tooth of the first group extends laterally outwardly on a first lateral side of the chainring;
the outer tooth side of each tooth of the second group extends laterally outwardly on a second lateral side of the chainring; and
in operation of the chain drive, a tooth of the first group is inserted into an outer link gap, with the outer tooth side inserted into a side recess formed in the outer link gap, and the central longitudinal axis of the drive chain is offset from the central plane of the chainring.

13. The bicycle chain drive according to claim 12, wherein
the plurality of teeth further comprises a single narrow tooth that has a narrower width than a width of the teeth of the first group and of the second group, and
the plurality of teeth comprises an odd number of teeth.

14. The bicycle chain drive according to claim 12, wherein
the outer tooth side of each tooth of the first group extends laterally outwardly beyond a chainring side wall on the first lateral side of the chainring; and
the outer tooth side of each tooth of the second group extends laterally outwardly beyond a chainring side wall on the second lateral side of the chainring.
